(19) United States
(12) Patent Application Publication
(10) Pub. No.: US 2023/0336052 A1
(43) Pub. Date: Oct. 19, 2023

(54) BALANCED STRUCTURE FOR CONNECTING CROSSBARS OF BICYCLE

(71) Applicant: Pengjun LIU, Zhengzhou (CN)

(72) Inventor: Pengjun LIU, Zhengzhou (CN)

(21) Appl. No.: 18/339,077

(22) Filed: Jun. 21, 2023

Related U.S. Application Data
(63) Continuation of application No. PCT/CN2021/141387, filed on Dec. 24, 2021.

(30) Foreign Application Priority Data
Dec. 27, 2020 (CN) 202023192025.6

(51) Int. Cl. H02K 1/12; B62J 45/00; H02K 7/14; H02K 7/00

(52) U.S. Cl. CPC H02K 7/14; B62J 45/00; H02K 1/12; H02K 7/003

(57) ABSTRACT

A balance structure for connecting crossbars of a bicycle, the balance structure comprising a bicycle frame body, crossbars, and a driving device (700), wherein the driving device (700) comprises a rotor (500) and a stator (400); and a first crossbar (100) is connected to a second crossbar (101) or a frame by means of the stator (400), a housing of the stator (400), or a central shaft (710) of the driving device (700).

### TECHNICAL FIELD

A balanced structure for connecting the top tube of a bicycle, mainly involving a balance structure of a bicycle, an electric two-wheeler and a two-wheeler toy.

### BACKGROUND

At present, self-balancing bicycles and unmanned bicycles are still developing, and there are no mature products, which mainly because the balance device is bulky that makes it difficult to be practical. The balance device frame or box mentioned in the patented CN 204197155 U and the patented CN 205010396 U are wide and require a large space under the pedal position to be stable and neat, but the gyro device requires a large space on the left and right, and the lightweight electric bicycle does not have the structural space of the pedal and cannot be placed stably. Patent number CN 201753096 U refers to a gyroscope placed on a frame, the position structure of the drive device is unknown, the volume is large, and it is difficult to be practical.

### SUMMARY OF THE INVENTION

The structure of the existing technical drive device is unknown, and adding a drive device for momentum wheels to a lightweight two-wheeled vehicle will make it difficult to mass produce and put it into practical use. A structure that simplifies the momentum wheel is needed. The drive is the most critical. Small size can not be driven, large volume is inconvenient to install, easy to affect the beauty and complexity of the whole vehicle structure.

A balanced structure for connecting crossbars of a bicycle, including a bicycle frame body, crossbars, a drive device, a rotating device, wherein the first crossbars and the second crossbars or frame are connected by the drive device, and the drive device drives the rotating device to rotate, and the control system controls the speed and direction or angular momentum of the drive device or rotating device according to the tilt of the gyro sensor or three-axis sensor, so as to realize the self-balance of the bicycle body.

It is characterized in that the drive device includes a rotor, a stator, a stator core or a stator casing or a stator central shaft connecting the first top tube to the second top tube or frame. The two sections of top tube are connected through the drive device, eliminating the problem that the top tube or other connection structure interferes with the size of the rotating device such as the runner and flywheel when the top tube is directly connected, and according to the specific model situation, the external rotor quality is sufficient when the rotating device is not installed.

Its advantage is that it is connected by the central shaft of the drive device, which reduces the length of the first top tube on one side of the head tube, facilitates the installation of the steering device inside the top tube on one side of the head tube, and avoids serious bending deformation of the bottom plate structure due to the excessive length of the top tube when there is a bottom plate structure in the top tube.

Its advantage is to save a section of top tube, avoid the installation method of runner around the top tube, the minimum inner diameter and volume of the drive device and flywheel are affected by the outer diameter of the top tube, reduce the redundancy of the top tube connection, simplify the structure, and greatly reduce the overall volume; Avoid the blockage caused by the direct connection of the frame to the radial outside of the drive or rotating device, resulting in structural redundancy and large space occupation.

It is characterized by the step on the central shaft of the stator connected with the D-shaped hole in the center of the second flange, and then fixed with the second flange by fasteners, such as bolts, and the second flange is connected with the first flange structure on the top tube by fasteners.

It is characterized in that the stator includes an iron core and coil, the central shaft of the drive device and the top tube are fixed and connected by flange or other connection methods of tubes or shafts, and the outer rotor casing or end cover or rotating device is rotated and connected with the top tube or the central shaft of the stator through the bearing to enhance the structural stability.

It is characterized in that the stator has a magnet, the central shaft of the magnet and the top tube are fixed with the top tube by flange or other tube connection, and the outer rotor coil and casing are rotated and connected with the top tube or the stator center shaft through the bearing, and the weight of the armature itself, as part of providing angular momentum, is installed in the outer rotor casing with a rotating device or runner rotating synchronously to generate a balance torque. The battery and drive are installed on the casing or in the rotating device, rotating synchronously with the coil, the advantage is that the drive or motor is controlled wirelessly, and the number of rotation turns is not affected by the cable. The advantage is that there is no excess transmission and the structure is simple.

It has high space utilization, makes full use of the structure of the bicycle body, and can give full play to the motor utilization rate with the largest volume of the same top tube; Makes full use of the cross-section of the top tube to exert the power or momentum of the motor at this size; Avoids structural redundancy caused by the direct connection of the frame on the radial outside of the drive or rotating device, which takes up a lot of space.

It is characterized in that the stator casing is connected to the top tube by flange, the central shaft of the drive device is rotated and connected to the flange by the bearing, and then connected to the top tube by the flange, and the rotating device is connected to the central shaft of the drive device.

The advantage is that the fasteners connecting the first flange and the second flange are outside the top tube, so that the first flange and the second flange can be fastened and connected through the nut, making the connection convenient, stable and reliable. Or the fasteners connected by the first flange and the second flange are inside the top tube, making the outside of the top tube more flat and simple.

Its advantage is that the inner diameter of the end cover or housing cavity is greater than or equal to the outer diameter of the flange, which can make the rotor casing cover the bearings on the top tube with the flange, the rotor end cover or casing or rotating device extends to the top tube part, and the outer rotor casing or end cover or rotating device is rotated and connected with the top tube or stator center shaft through the bearing, and the appearance looks more concise and flat.

The end cover or casing is split with a concave and convex structure or bolts between the two.

Its advantage is that there are through-holes or core hollows in the center of the stator, and the built-in brake line and shift line pass through it to avoid the external cable being affected by the rotating device.

### BRIEF DESCRIPTION OF THE DRAWINGS

FIG. 1 shows a schematic diagram of a balanced structure for connecting the top tube of a bicycle according to Example 1.

FIG. 2 shows a schematic diagram of a balanced structure for connecting the top tube of a bicycle according to Example 2.

FIG. 3 shows a schematic diagram of a balanced structure for connecting the top tube of a bicycle according to Example 3.

FIG. 4 shows a schematic diagram of a balanced structure for connecting the top tube of a bicycle according to Example 4.

FIG. 5 shows a schematic diagram of a balanced structure for connecting the top tube of a bicycle according to Example 5.

FIG. 6 shows a schematic diagram of a balanced structure for connecting the top tube of a bicycle according to Example 6.

### DETAILED DESCRIPTION OF THE INVENTION

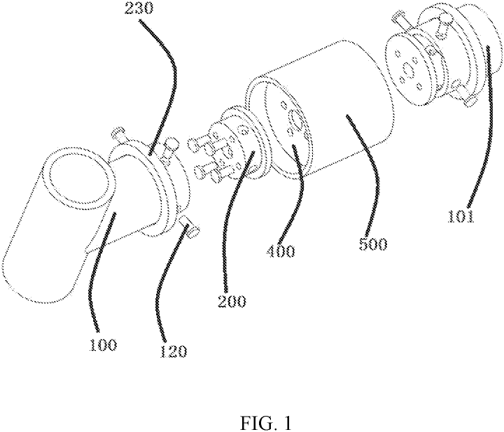

As in FIG. 1 according to Example 1, a balanced structure for connecting the top tube of a bicycle, including a bicycle frame body, a top tube, a drive device, the top tube includes a first top tube 100 and a second top tube 101, the first top tube 100 and the flange 200 are fixed connected by a fastener 120. The drive device comprises a stator 400 and a rotor 500, stator 400 housing and flange 200 fixed by fasteners. The rotor 500 end cover or casing or rotating device extends to the top tube portion, and the outer rotor 500 casing or end cover or rotating device is connected to the top tube 100 rotary connection via bearing 230. The other side of the stator 400 and the second top tube 101 or frame fixed connection process is the same as the above or other tube and shaft connection method. When the drive device is working, the rotor 500 of the drive device rotates to obtain a balance torque, according to the specific conditions of the bicycle body, the rotor 500 can be connected to the wheel or rotating device to increase the angular momentum, and change the speed or direction under the control of the controller and the drive, so that the bicycle tends to self-balance.

### EMBODIMENTS

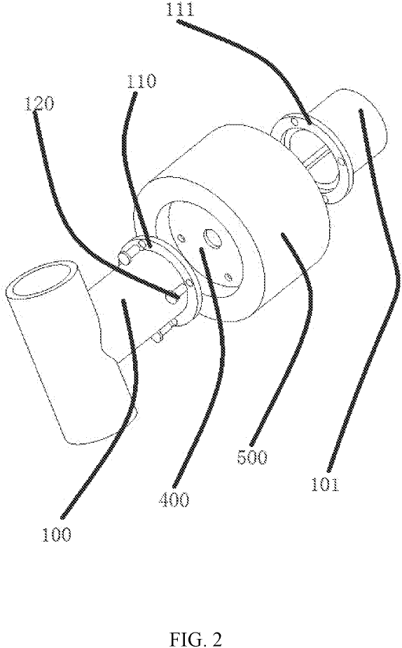

As shown in FIG. 2 according to Example 2, a balanced structure for connecting the top tube of a bicycle, including a bicycle frame body, a top tube, a drive device, the top tube includes a first top tube 100 and a second top tube 101, the first top tube 100 is connected to the first flange 110. The drive device comprises a stator 400, a rotor 500, a stator 400 housing and a flange hole of the first flange 110 fixed by a fastener 120. The other side of the stator 400 and the second top tube 101 or frame fixed connection process is the same as the above or other tube and shaft connection method. When the drive device is working, the rotor 500 of the drive device rotates to obtain a balance torque, according to the specific conditions of the bicycle body, the rotor 500 can be connected to the wheel or rotating device to increase the angular momentum, and change the speed or direction under the control of the controller and the drive, so that the bicycle tends to self-balance.

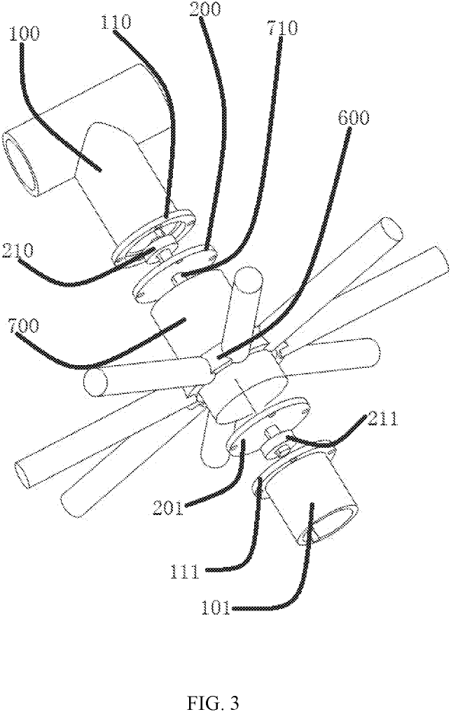

As in FIG. 3 according to Example 3, a balanced structure for connecting the top tube of a bicycle, including a bicycle frame body, a top tube, a drive device, a rotating device, a top tube comprising a first top tube 100 and a second top tube 101, the first top tube 100 is connected to the first flange 110. The center shaft 710 of the drive 700 is fixed with fastener 210 through the D-shaft bore in the center of the second flange 200. The second flange 200 and the first flange 110 are connected by fasteners, such as screws (not shown). The fixed connection process of the central shaft 710 and the second top tube 101 or frame is the same as the connection method described above or other tubes and shafts. When the drive device 700 is working, the drive device 700 casing rotates to drive the wheel-like rotating device 600 connected to it to rotate, and changes the speed or direction under the control of the controller and drive, so that the bicycle tends to self-balance.

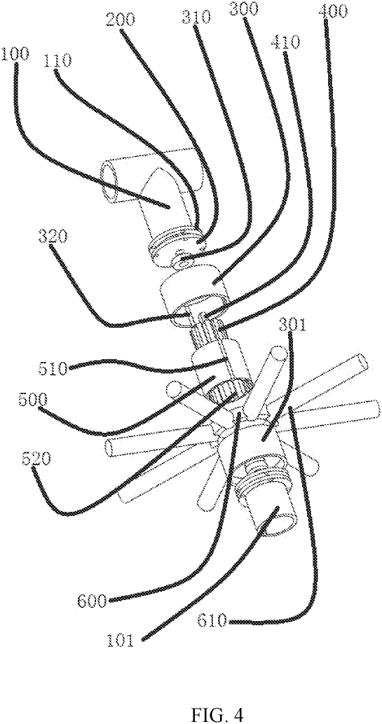

As in FIG. 4 according to Example 4, a balance structure of a bicycle, including a bicycle frame body, a top tube, a drive device, a rotating device, a top tube comprising a first top tube 100 and a second top tube 101, the first top tube 100 has a first flange 110. The drive device includes a stator 400, a rotor casing 500, a stator 400 central shaft 410 is rotatingly connected with the end cover 300 by bearing 310, and then the central shaft 410 of the stator 400 is fixed by a fastener through the D-shaft hole in the center of the second flange 200. The second flange 200 and the first flange 110 are connected by fasteners, such as screws (not shown). The other end of the central shaft 410 is fixed with a second top tube 101 or frame as described above. The groove 320 on the end cover 300 and the convex grain 510 on the casing 500, fit and connect; The end cover 300 and the end cover 301 are split connected by fasteners, such as screw rods; The end cover 300 and the end cover 301 extend outward, the inner diameter of the flange is greater than or equal to the outer diameter of the flange, and the extension part covers the flange; The appearance looks flat; The end cover 300 is rotated and connected with the first top tube 100 or stator center shaft 410 by a bearing. Rotating device 600, such as a runner and a rotating arm, is connected to the end cap 300 or end cap 301 or casing 500.

In Example 4, there is a permanent magnet on the stator 400, the coil 520 on the rotor casing 500, the battery or drive is mounted on the outer perimeter of the casing 500 or on a rotating device, and the coil 520 rotates synchronously, and the drive or motor is controlled wirelessly to work. Coil 520 provides a larger counterweight than magnets. In a specific embodiment, it may also be a coil on the stator 400, and a permanent magnet on the rotor casing 500. The outer rotor casing 500 is rotated and connected by bearings to the top tube or stator center shaft.

In Example 4, the end cap 300 extends the inner cavity covered with a flange, and the inner cavity structure may also replace the end cap 300 on a separate rotating or stationary housing.

In Example 4, the end cover 300 and the rotor casing 500 are integrated or split, fixed by a concave and convex structure, or may be fastened or buckled by a screw around the wind.

In Example 3, Example 4, the first top tube 100 and the first flange 110 may be integrated, may also be a split combination or welded.

In Example 3, Example 4, the connection of the first flange 110 and the second flange 200 may be on the outside of the top tube or can be fastened in the top tube.

In Example 3, Example 4, depending on the specific model situation, the rotor or casing mass or speed is sufficient when the rotating device 600 is not installed.

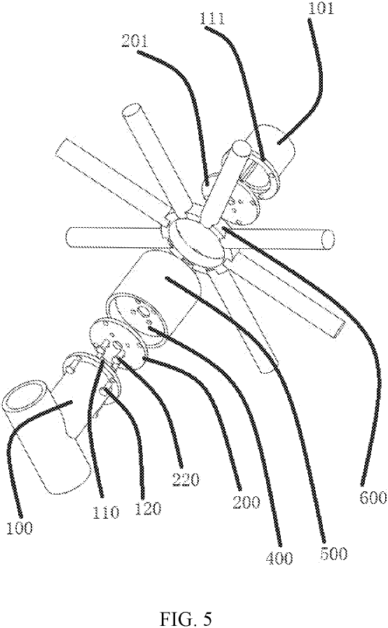

As in FIG. 5 according to Example 5, a balanced structure for connecting the top tube of a bicycle, including a bicycle frame body, a top tube, a drive device, a top tube includes a first top tube 100 and a second top tube 101, the first top tube 100 is connected to the first flange 110. The threaded hole inside the stator 400 housing of the drive device and the second flange 200 is fixed by fastener 220, and the flange hole on the outside of the second flange 200 is fixed with the first flange 110 through fastener 120. The other end of the stator 400 and the second top tube 101 or frame fixed connection process is the same as the above or other tube or shaft type connection method. When the drive device is working, the rotor 500 of the drive device obtains the balance torque under rotation, according to the specific conditions of the bicycle body, the rotor 500 can be connected to the wheel or rotating device 600 to increase the angular momentum, change the speed or direction under the control of the controller and the drive, so that the bicycle tends to self-balance.

In Example 1, Example 2, Example 3, Example 4, Example 5, the stator center has a through hole or core hollow suitable for the passage of built-in brake line and gear line.

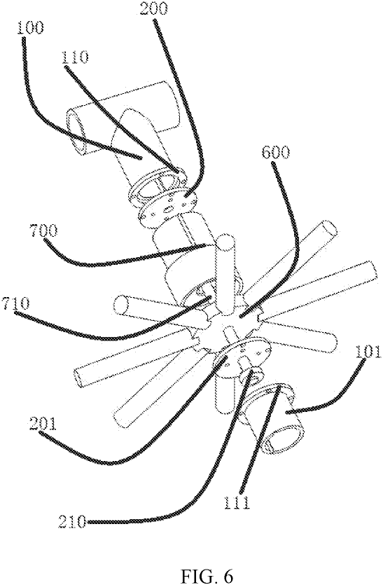

As shown in FIG. 6 according to Example 6, a balanced structure for connecting the top tube of a bicycle, including a bicycle frame body, a top tube, a drive device, a rotating device; The top tube includes a first top tube 100 and a second top tube 101, the first top tube 100 has a first flange 110. The drive device 700 central shaft 710 is equipped with a rotating device 600, such as a runner and a rotating arm, the central shaft 710 as part of the drive device 700 rotor is rotated with the third flange 201 by a bearing, and then connected with the locking ring 210, the locking device may also be on both sides of the flange. The position of the motor is fixed by the rotating device 600 or locking ring 210. The third flange 201 is connected to flange 111 on the second top tube 101. The second flange 200 is first fixed connected with the drive device 700, and then connected with the first flange 110 by a fastener, such as a screw (not shown).

Example 6 uses a single output shaft motor.

In Example 6, the rotor center shaft and the top tube are connected by flange and top tube rotation, the drive device 700 casing and the top tube are fixed by a flange, the second flange 200 inner ring is fixed with the drive device 700 casing, and the second flange 200 outer ring is fixed connected with the first flange 110.

In Example 1, Example 2, Example 3, Example 4, Example 5, Example 6, the outer rotor of the drive device may be with a permanent magnet, the inner stator with an armature coil, or an outer rotor armature coil, an inner stator with a permanent magnet.

In Embodiment 1, Embodiment 2, Embodiment 3, Embodiment 4, Embodiment 5, Embodiment 6, the flange as a connecting device in the middle of the tube or shaft may be simplified and removed according to the specific situation.

What is claimed is:

1. A balanced structure for connecting top tube of a bicycle, comprising a top tube, a driving device, wherein the driving device comprises a rotor and a stator, and is characterized in that the first top tube is connected to the second top tube or the vehicle frame by means of a stator or a stator housing or a central shaft of the driving device.

2. The balanced structure as claimed in claim 1, wherein the top tube or frame is connected with the stator or stator housing or the central shaft of the driving device by a fastener or flange.

3. The balanced structure as claimed in claim 1, wherein the central shaft of the drive device is connected with the center hole of the second flange, and then fixed with the second flange by a fastener, the second flange is connected to the first flange structure on the top tube by a fastener, and the other end of the central shaft is connected to the top tube in the same way.

4. The balanced structure as claimed in claim 1, wherein the stator includes an iron core and a coil, the stator center shaft and a top tube are fixed connected by a flange to itself or frame, and an end cover or casing is rotated and connected to a top tube or stator center shaft by a bearing.

5. The balanced structure as claimed in claim 1, wherein the stator has a magnet, the rotor with a coil, the stator center shaft and the top tube are fixed connected to itself or frame by flange, and the end cover or casing is rotated and connected to the top tube or stator center shaft by bearing.

6. The balanced structure as claimed in claim 1, wherein the stator comprises iron cores and coils, a rotor with magnet, a rotor center shaft is rotated and connected by a locking ring with the flange center hole, and the outer stator bicycledinal casing or end cover is fixed with a top tube or fixed by a flange.

7. The balanced structure as claimed in claim 1, wherein the drive casing or drive device center shaft is mounted with a rotating device or runner.

8. The balanced structure as claimed in claim 7, wherein the rotor end cover or casing or rotating device extends to the top tube portion, and the outer rotor casing or end cover or rotating device is connected by bearing rotation with the top tube or stator center shaft.

9. The balanced structure as claimed in claim 1, wherein there is a through hole or core hollow in the center of the stator, and a built-in brake line and a shift line pass through it.

10. The balanced structure as claimed in claim 5, wherein there is a battery or drive outside the rotor or casing, rotating synchronously with the coil on the rotor, and controlling the drive or motor to work by wireless means.
